(19) United States
(12) Patent Application Publication
(10) Pub. No.: US 2022/0179240 A1
(43) Pub. Date: Jun. 9, 2022

(54) CONTACT LENS

(71) Applicant: EYES COLOR CO., LTD., New Taipei City (TW)

(72) Inventor: Po-Jen LAI, Xinbei City (TW)

(21) Appl. No.: 17/525,379

(22) Filed: Nov. 12, 2021

(30) Foreign Application Priority Data
Dec. 3, 2020 (CN) 202022864451.3

(51) Int. Cl. G02C 7/06

(52) U.S. Cl. CPC G02C 7/066

(57) ABSTRACT

A contact lens is provided. The contact lens, which is round, has a side shearing at inside edge and has defocusing zone or multifocal zone near the central optical zone. The defocusing zone maintains a hyperopia or myopia diopter to avoid the user's myopia diopter increase.

### RELATED APPLICATION

The instant application claims priority to Chinese Patent Application 202022864451.3, filed on Dec. 3, 2020, which is incorporated herein by reference.

### TECHNICAL FIELD

The disclosure relates to the technical field of vision correction, in particular to a new type of contact lens.

### BACKGROUND

As shown in FIG. 1, light is refracted from an object (40) to the eyes of user. The user's eyeball (20) use iris (26) to adjust the size of the pupil (28). The lens (22) allows the light to produce an image (32) on the retina (24). For example, the user's eyes do not have good vision, such as hyperopia, myopia, amblyopia, etc., it is necessary to wear a pair of glasses to correct the vision of user.

Known glasses are distinguished: contact lens and non-contact lens. The contact lens is the contact lens (42) that contacts the eyeball (20). The central area of the contact lens (42) is focused a corrected imaging (34), which is incident on the retina (24) to produces a clear image (32).

However, the peripheral area of the contact lens (42) with the same refractive power produces multiple peripheral unfocused vision (31). The focal points (33) and (35) of the peripheral unfocused vision (31) are behind the retina (24), forming blurred images. For see the image clearly, the axial length of the eyeball (20) is changed to let the focal points (33) and (35) can fall on the retina (24), which will damage the eyesight, such as increase myopia.

### SUMMARY

In view of this, the purpose of the present disclosure is to provide a new type of contact lens that uses a peripheral defocusing zone structure to prevent the user's vision from deteriorating.

In order to solve the above technical problems, the technical solution of the present disclosure is: a new type of contact lens, including a round lens (10), a base curve (18) is formed on the inner side of the lens (10), and the outer side of the lens (10) has a central optical zone (12), the central optical zone (12) has a diopter for correcting vision, a defocusing zone (14) is arranged on the outside of the lens (10), and the defocusing zone is arranged outside the central optical zone (12), the defocusing zone has a diopter capable of correcting vision.

The defocusing zone (14) is around the central optical zone (12) by concentric circles, and the defocusing zone (14) maintains a hyperopic diopter of +4.00D.

The defocusing zone (14) which is arranged around the central optical zone (12) by concentric circles, the defocusing zone (14) is provided with a plurality of zooming zones, and the plurality of zooming zones are also around the central optical zone (12) by concentric circles, so that the peripheral defocusing zone (14) has progressive diopters of hyperopia and myopia.

The diameter of the defocusing zone (14) ranges from 3 mm to 8 mm.

The partial defocusing zone (13) is next to the central optical zone (12), and the partial defocusing zone (13) maintains one diopter of myopia or hyperopia.

The partial defocusing zone (13) is a convex curved on the front side of the lens (10).

The edge of the base curve (18) connecting the lens (10) has a side shearing area (16).

The base curve (18) has a radius of curvature of 8-9 mm.

The diameter of the central optical zone (12) is about 3 mm.

The technical effect of the disclosure is mainly by adopting the structure of the defocusing zone, and the defocusing zone has the diopter of hyperopia or myopia with the central optical zone (12) for correcting vision, which is different from the central optical zone (12), but can prevent the eye axis become longer, prevents the user's vision from deteriorating.

### DESCRIPTION OF THE DRAWINGS

FIG. 1 is a schematic diagram of the prior art;

FIG. 2 is a schematic diagram of Embodiment 1 of the disclosure;

FIG. 3 is a schematic side view of Embodiment 1 of the disclosure;

FIG. 4 is a schematic diagram of the use state of Embodiment 1 of the is disclosure;

FIG. 5 is a schematic side view of Embodiment 2 of the disclosure;

FIG. 6 is a schematic diagram 1 of Embodiment 3 of the disclosure;

FIG. 7 is a schematic diagram 1 of Embodiment 3 of the disclosure.

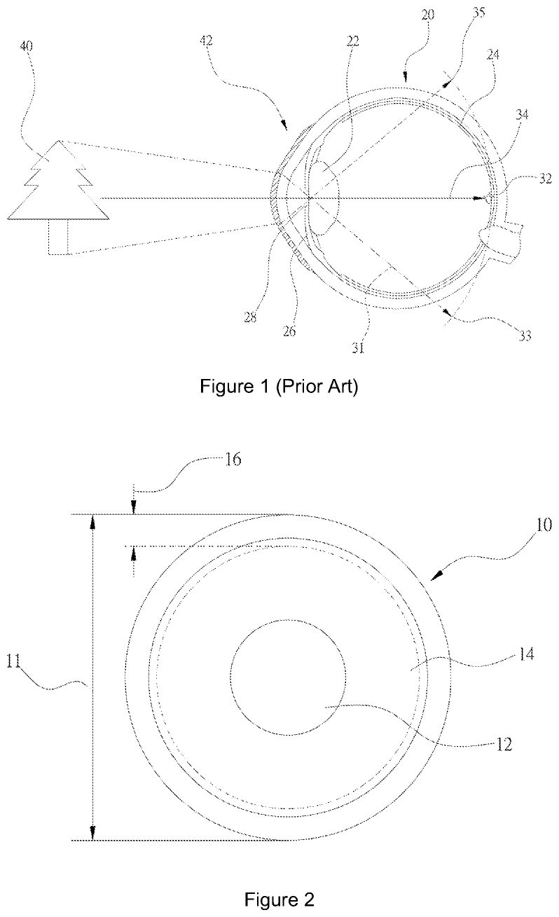

### DETAILED DESCRIPTION

The specific embodiments of the present disclosure will be described in further detail below in conjunction with the accompanying drawings, so as to make the technical solution of the present disclosure easier to understand and grasp.

### EXAMPLE 1

As shown in FIG. 2, a new type of contact lens includes a round light-permeable lens (10). The linear distance between two points opposite to the edge of the lens (10) through the center of the circle is defined as a diameter (11), the lens (10) is usually divided into two types of contact lens: hard contact lens and soft contact lens. In the past, hard contact lenses are usually made of polymethylmethacrylate (PMMA). For now, rigid gas-permeable contact lenses (Rigid Gas-Permeable, RGP) are the mainstream. The soft lens is made of materials with strong hydrophilicity, such as hydroxyethylmethacrylate (HEMA) polymer. From the perspective of top view or front view, the lens (10) has a central optical zone (12), a peripheral defocusing zone (14), and a side shearing area (16) that are concentric circles. The central optical zone (12) is in the center of the lens (10) and is a round area with a diameter of about 3 mm, the peripheral defocusing zone (14) is a peripheral defocusing zone, and the peripheral defocusing zone (14) surrounds the central optical zone (12) with a diameter of 3 mm to 8 mm. The peripheral defocusing zone (14) may or may not cover the side shearing area (16).

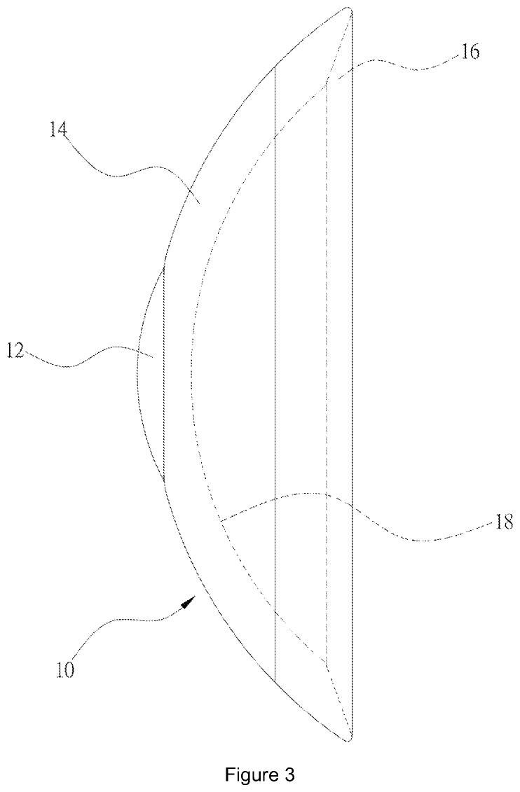

As shown in FIG. 3, it is the side surface of the contact lens of Example 1. The contact lens (10) shows that the side shearing area (16) presents a cone surface. The end is connected to the base curve (18) and lens (10), the base curve (18) is a concave curved surface that inside of the lens (10), and the concave curved surface has a curvature with a radius of about 8 mm-9 mm, which is for the lens (10) to matches the curvature of the eyeball.

In the figure, the central optical zone (12) is a convex curved surface on the outside of the lens (10), and the convex curved surface makes the central optical zone (12) have a diopter. According to the formula D=1/f, it means that the diopter (D) is the reciprocal of the focal length (f). For example, if the focal length is 15 m, the diopter is 1/15. Traditionally, the diopter is multiplied by 100 to convert to a glasses diopter. For example, the central optical zone with a diopter of −3.75 D, a negative number (−) of the diopter, represents a diopter of 375 for correcting the myopia. Assuming that the diopter of the central optical zone (12) is +1.00 D, a positive (+) of the diopter, represents a diopter of 100 for correcting hyperopia. Therefore, the central optical zone (12) enables the lens (10) to correct myopia, hyperopia, or astigmatism.

In addition, the peripheral defocusing zone (14) is also a convex curved surface on the outside of the lens (10), and the convex curved surface keeps the defocusing zone constant at +4.00 D (hyperopia) diopter.

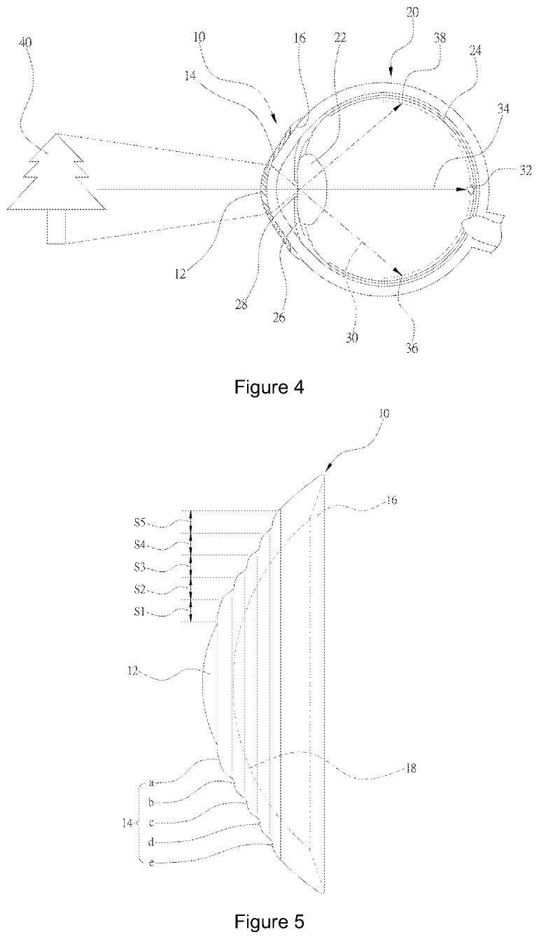

As shown in FIG. 4, it shows the eyeball (20) wearing the contact lens in the status of use, when wearing the lens, the edge of the lens (10) will not pricking the cornea, so that the side shearing area (16) fits the eyeball (20). The external light is refracted by the object (40) to the central optical zone (12) of the lens (10), and a light of center-corrected sight (34) is generated according to the diopter, and incident on the retina (24) to produce a reflection (32), the clear reflection of the object (40).

At the same time, external light is refracted to the peripheral defocusing is zone (14) of the lens (10) through the object (40), and multiple peripheral defocus lights (30) are generated by the diopter of the hyperopia, which are focused in front of the retina (24) to form multiple focal points (36) and (38). The lens (10) is equipped with bifocals. So the axial length of the eyeball (20) does not need to be excessively elongated when users see the image clearly, and the deterioration of vision can be prevented more than in the prior art.

### EXAMPLE 2

FIG. 5 is a side view of Embodiment 2. The difference from Embodiment 1 is that the contact lens is a multifocal lens (10), that is, it has the peripheral defocusing zone (14) with progressively multifocal.

Under the condition of equal diameter, the peripheral defocusing zone (14) is composed of a plurality of concentric circular circle areas. From the central optical zone (12) to the edge of the lens (10), these circle areas are defined as the first zoom zone a, the second zoom zone b, the third zoom zone c, the fourth zoom zone d, and the fifth zoom zone e , between of each other are regarded as the radius distance S1, S2, S3, S4, S5.

For example, the first zoom zone a with a radius distance S1 of 2 mm surrounds the central optical zone (12); the second zoom zone b is an annular zone with a radius distance S2 of 2 mm, which surrounds the first zoom zone a; The third zoom zone c with a radius distance S3 of 2 mm, surrounds the second zoom zone b; the fourth zoom zone d is a circle area with a radius distance S4 of 2 mm, surrounds the third zoom zone c; the radius distance S5 The fifth zoom zone e of 2 mm surrounds the fourth zoom zone d.

The “multifocal” here generally refers to the focus of multiple diopters may all be the hyperopia, or myopia, or these diopters may be multiple focal points of hyperopia or myopia.

To put it simply, the diopters of the five zoom zones are all positive (+), so that the peripheral defocusing zone (14) has five focal points with different hyperopia powers; or, the diopters of the five zoom zones are all negative (−) , Let the peripheral defocusing zone (14) maintain five focal points with different myopia powers; or, the diopter of the zoom zone is alternately positive (+) and negative (−), Example in the first zoom zone a of the myopia, will just between the central optical zone (12) and the second zoom of hyperopia zone b; or, the fourth zoom zone d with the hyperopia, between the third zoom zone c and the fifth zoom zone e of the myopia. In this way, the peripheral defocusing zone (14) with progressively multifocal continuously changes the focus of the light incident on the eyeball, and the user wearing the lens (10) is trained to restrain the eye axis from being excessively elongated.

### EXAMPLE 3

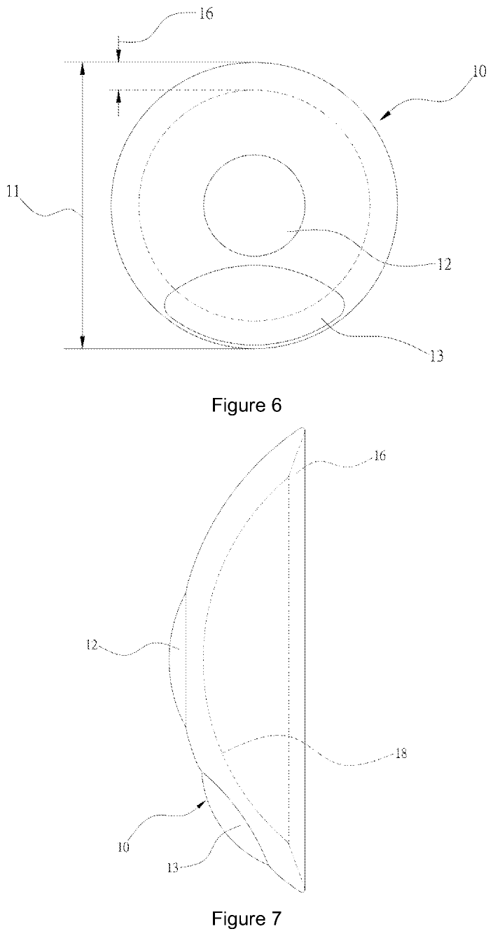

FIG. 6 is a front view of Embodiment 3. The difference from Embodiment 1 is that there is no peripheral defocusing zone (14), and a partial defocusing zone (13) is provided next to the central optical zone (12), so that the contact lens (10) is still the bifocal.

FIG. 7 is a side view of Embodiment 3, showing that the partial defocusing zone (13) is a convex curved surface formed on the outside of the lens (10), and the convex curved surface has a diopter of Add+150 for hyperopia, or a diopter of Add−0.75 for myopia. During wearing, the weight of the partial defocusing zone (13) keeps the lens (10) in the middle position of the eyeball (20) as much as possible, resulting normally the central optical zone (12) being above the partial defocusing zone (13). Through the central optical zone (12) corrects the vision of the user. Therefore, the partial defocusing zone (13) helps the user of the lens (10) to feel a relaxed and comfortable use effect.

What is claimed is:

1. A contact lens, comprising:
a round lens, wherein:
a base curve is formed on an inner side of the round lens,
a central optical zone is provided on an outer side of the round lens,
the central optical zone has a diopter for correcting vision,
a defocusing zone is provided on the outer side of the round lens,
the defocusing zone surrounds the central optical zone, and
the defocusing zone has a diopter configured for correcting vision.

2. The contact lens according to claim 1, wherein:
the defocusing zone is around the central optical zone by concentric circles, and
the defocusing zone maintains one diopter of hyperopia.

3. The contact lens according to claim 2, wherein the defocusing zone maintains a hyperopic diopter of +4.00 D.

4. The contact lens according to claim 1, wherein:
the defocusing zone is around the central optical zone by concentric circles,
the defocusing zone is provided with multiple zoom areas,
the multiple zoom areas also surround the central optical zone by concentric circles, and
the defocusing zone has hyperopia and myopia diopter by progressive.

5. The contact lens according to claim 2, wherein a diameter of the defocusing zone is from 3 mm-8 mm.

6. The contact lens according to claim 1, wherein:
a partial defocusing zone is beside the central optical zone, and
the partial defocusing zone maintains one diopter of hyperopia or myopia.

7. The contact lens according to claim 6, wherein:
the partial defocusing zone is a convex curved surface.

8. The contact lens according to claim 1, wherein:
an edge of the base curve has a side shearing connected to the round lens.

9. The contact lens according to claim 8, wherein the base curve has a radius of curvature of 8-9 mm.

10. The contact lens according to claim 1, wherein a diameter of the central optical zone is about 3 mm.
